(19) United States
(12) Patent Application Publication
(10) Pub. No.: US 2006/0123173 A1
(43) Pub. Date: Jun. 8, 2006

(54) Multimedia playback system and method of detecting an extended device thereof

(76) Inventors: Ying-Lang Chuang, Hsinhua (TW); Lin-Kai Bu, Hsinhua (TW)

Correspondence Address: MCDERMOTT WILL & EMERY LLP, 600 13TH STREET, N.W., WASHINGTON, DC, 20005-3096, US

(21) Appl. No.: 11/273,256

(22) Filed: Nov. 15, 2005

(30) Foreign Application Priority Data
Nov. 15, 2004 (TW) 93134992

(51) Int. Cl. G06F 13/00

(52) U.S. Cl. 710/300

(57) ABSTRACT

A multimedia playback system and method of detecting an extended device thereof is provided. The multimedia playback system includes an extended device, a system bus and a host. The system bus includes video buses and audio buses. First, the host detects an identification of the extended device through the system bus. Next, the host detects these video buses to determine the video bus coupled to the extended device. Then, the host detects these audio buses to determine the audio bus coupled to the extended device.

This application claims the benefit of Taiwan application Serial No. 93134992, filed Nov. 15, 2004, the subject matter of which is incorporated herein by reference.

### BACKGROUND OF THE INVENTION

1. Field of the Invention

The invention relates in general to a multimedia playback system, and more particularly to a multimedia playback system and method of detecting an extended device thereof.

2. Description of the Related Art

Typically, an electrical product with high extensibility is designed such that various extended peripheral devices can be added as customers require after the product is made available to them. For example, an extendable TV set is designed such that a retail seller can add a DVD ROM, or DVB-T tuner module thereto when the buyer is willing to pay more for it.

However, for adoption of the peripheral device, the internal design of the product typically has to be modified by way of, for example, re-programming the firmware or changing the circuit in part. Such modification necessitates a lot of time, money and skills, which is disadvantageous to fast integration of new functions into the existing product. Thus, it is an important target of the designers to achieve a highly convenient connection between the extendable product and peripheral devices.

### SUMMARY OF THE INVENTION

It is therefore an object of the invention to provide a multimedia playback system and method of detecting an extended device thereof.

The invention achieves the above-identified object by providing a multimedia playback system, which comprises a system bus, an extended device and a host. The system bus comprises video buses and audio buses. The extended device outputs a video signal and an audio signal through the video bus and the audio bus coupled thereto, respectively. The host coupled to the system bus receives and plays the video signal and the audio signal, and detects an identification of the extended device and the video bus and the audio bus coupled to the extended device through the system bus.

The invention also achieves the above-identified object by providing a method of detecting an extended device in a multimedia playback system, which includes a system bus and a host. The system bus includes a control bus, a plurality of video buses and a plurality of audio buses. First, the host detects an identification (ID) of the extended device through the system bus. Next, the host detects the video buses to determine the video bus coupled to the extended device. Then, the host detects the audio buses to determine the audio bus coupled to the extended device.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a multimedia playback system according to a preferred embodiment of the invention.

FIG. 2 is a flow chart showing a method of detecting an extended device according to the preferred embodiment of the invention.

FIG. 3 is a flow chart showing a method of detecting a parameter of an extended device.

### DETAILED DESCRIPTION OF THE INVENTION

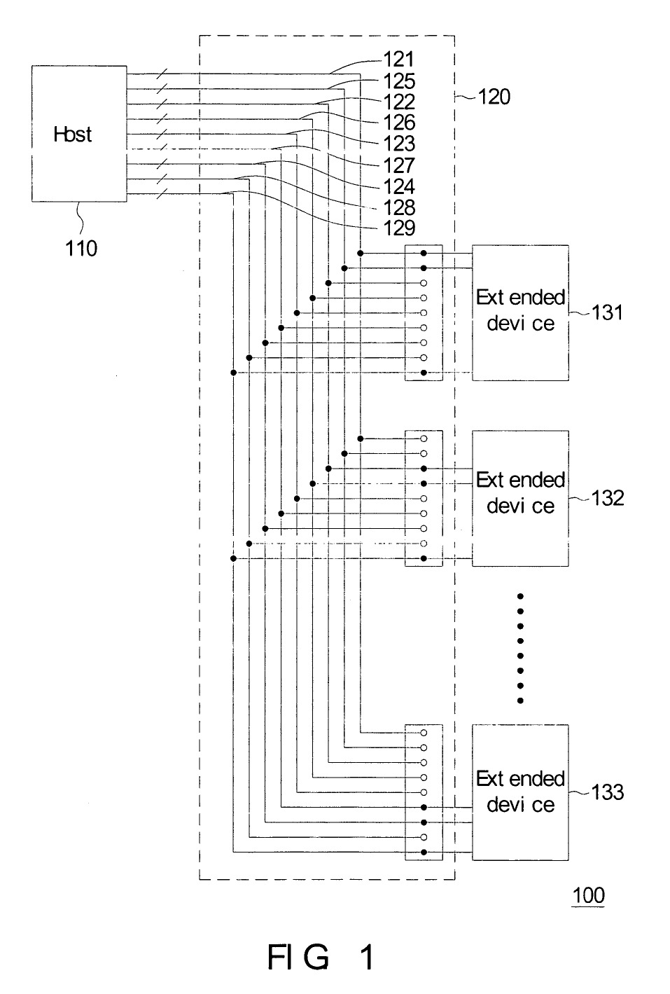

FIG. 1 is a schematic illustration showing a multimedia playback system according to a preferred embodiment of the invention. Referring to FIG. 1, the multimedia playback system 100 includes a host 110, a system bus 120 and extended devices 131, 132 and 133. The extended devices 131 to 133 may include, for example, various multimedia devices, such as a DVD playing unit, a digital television playing unit or a recording unit. The system bus 120 includes video buses 121 to 124 having different specifications, audio buses 125 to 128 having different specifications, and a control bus 129. The video buses 121 to 124 satisfy, for example, the low voltage differential signaling (LVDS) specification, the digital visual interface (DVI) specification, the chromatic video specification, the S video specification or the composite video specification. The audio buses 125 to 128 satisfy, for example, the I2S (Inter-IC Sound) interface specification, the SPDIF (Sony/Philips Digital Interface Format) interface specification and/or the AC'97 (Audio Codec '97) specification. The control bus 129 satisfies the RS422 (Recommended Standard-422) interface specification or the I2C (Inter-Integrated Circuit) specification. The bus includes, without limitation to, the above-mentioned interfaces as long as the usable signal lines are sufficient.

The extended device 131 outputs a video signal and an audio signal respectively through the video bus 121 and the audio bus 125 coupled to the extended device 131. The extended device 132 outputs a video signal and an audio signal respectively through the video bus 122 and the audio bus 126 coupled to the extended device 132. The extended device 133 outputs a video signal and an audio signal respectively through the video bus 124 and the audio bus 127 coupled to the extended device 133. The host 110 coupled to the system bus 120 receives the video signals and the audio signals outputted from the extended devices 131,132 and 133.

In the prior art, if an additional extended device has to be added, the firmware or circuit has to be modified in order to record the parameters for the extended device. For example, the parameters may identify the used video bus, the used audio bus, and the functions of the extended device. However, this will slow down the researching and developing speed, and the time schedule for the new product to be sold in the market will be elongated. This embodiment can automatically detect the parameters of the extended device without modifying the firmware, such that the hardware or firmware does not have to be modified when an extended device is added, and the researching and developing speed can be increased.

In this embodiment, an identification (ID) is assigned to each extended device and recorded in its read only memory (ROM) before the extended device is shipped out. In addition, identification data, which comprise various registered identifications and parameters of the extended device, are built in the firmware of the multimedia playback system 100.

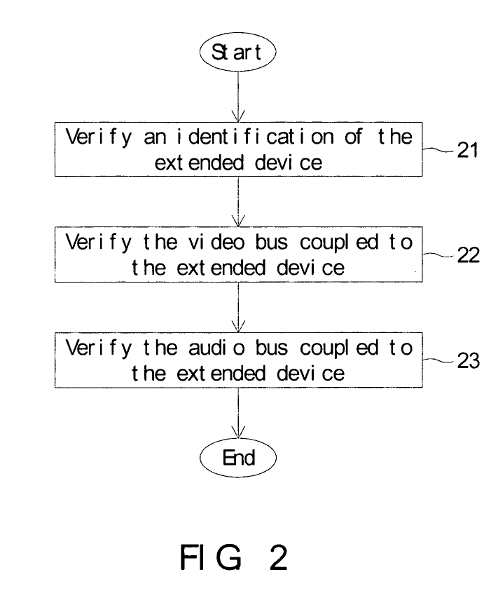

When the manufacturer of the multimedia playback system 100 wants to incorporate the extended devices 131 to 133 into the product, the identifications of the extended devices 131 to 133 can be detected during the initial stage. Then, the parameters of the extended devices 131 to 133 can be obtained according to the identification data in the firmware of the multimedia playback system, and the extended devices can be operated. FIG. 2 is a flow chart showing a method of detecting an extended device according to the preferred embodiment of the invention. First, the identification of the extended device in the multimedia playback system 100 is verified, as shown in step 21. Thereafter, the video bus coupled to the extended device is verified, as shown in step 22. Then, the audio bus coupled to the extended device is verified, as shown in step 23. Steps 21 to 23 can be performed in any suitable order. In steps 22 and 23, the host 110 detects the video buses 121 to 124 and the audio buses 125 to 128 through the system bus 120 so as to determine the video bus and the audio bus coupled to the extended devices 131 to 133.

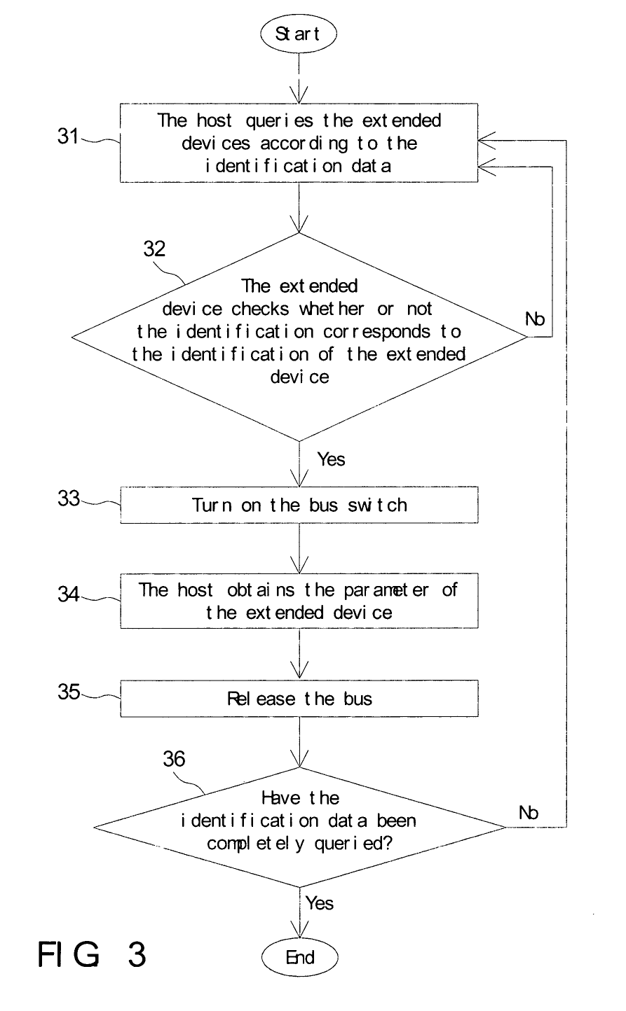

FIG. 3 is a flow chart showing a method of detecting a parameter of the extended device. When the multimedia playback system 100 is activated at first, the host 110 queries, one by one, the extended devices 131 to 133 through the system bus 120 according to the identification data in the firmware of the host 110, as shown in step 31. Then, the extended device judges whether or not the identification queried by the host 110 corresponds to the identification of the extended device, as shown in step 32. If not, the process goes back to step 31. If yes, the bus switch occupied by the extended device corresponding to the identification is turned on, as shown in step 33. Thereafter, the host 110 obtains the information that the bus switch occupied by the extended device is turned on, and thus obtains the parameter of the extended device, as shown in step 34. Next, the host 110 outputs a release command to release the bus from being occupied by the extended device, as shown in step 35. Finally, the host 110 verifies whether or not the identification data have been queried, as shown in step 36. If yes, this method ends; and if no, the process goes back to step 31.

In step 33, the mentioned bus is the control bus 129, the video bus or the audio bus, and the mentioned switch is coupled to a control wire of the control bus 129, a conductive wire of the video bus, or a conductive wire of the audio bus, for example. In step 34, the turned on switch biases the control wire of the control bus, the conductive wire of the video bus, or the conductive wire of the audio bus at a low voltage, such that the host obtains the parameters of the extended device, such as the identification, the video bus occupied by the extended device, or the audio bus occupied by the extended device. In step 35, the released bus may be the control bus 129, the video bus occupied by the extended device, or the audio bus. occupied by the extended device, for example. In the above-mentioned steps 33, 34 and 35, the parameters, such as the identification of the extended device, the occupied video bus or the occupied audio bus, may be obtained. In steps 33, 34 and 35, it is also possible to detect the identification of the extended device, the occupied video bus or the occupied audio bus. Thus, the flow chart of FIG. 3 can be applied to step 21, 22 or 23 of FIG. 2, and steps 21, 22 and 23 can be performed simultaneously in order to speed up the query.

For example, it is assumed that the identification data recorded in the host 110 include ten extended devices having the identifications of 1 to 10, respectively, and the identifications of the extended devices 131 to 133 are 1, 3 and 7, respectively. When the host 110 outputs a driving command of the information including the identification of 1 to the extended devices 131 to 133, the extended device 131 turns on the switches of the control bus 129, the video bus 121 and the audio bus 125 because the identification of the extended device 131 is 1. Thus, the host 110 can know that the extended device 131 with the identification of 1 exists and the video bus and the audio bus occupied by the extended device 131. When the host 110 outputs the driving command of the information including the identification of 2 to the extended devices 131 to 133, no extended device will turn on the switches of the control bus 129, the video bus and the audio bus because no extended device with the identification of 2 is coupled to the host 110. The host 110 can know that the extended device with the identification of 2 does not exist. Such a sequential query enables the host 110 to obtain the identifications of the extended devices coupled thereto are 1, 3 and 7, as well as the video buses and the audio buses occupied by the extended devices. In addition, the host 110 may also utilize the binary search method to speed up the query, and detailed descriptions thereof will be omitted.

When the extended device is coupled to the multimedia playback system, a remote controller for switching is often used because the video buses and the audio buses are used repeatedly. Thus, it is possible to view the extended devices displayed on the monitor of the host, and the function and switching are set using the keys of the remote controller. For example, the multimedia playback system can obtain the extended devices of the system at first, and then switch between the extended devices using the remote controller. During the switching, the new extended device is not allowed to use the originally occupied bus until the bus used by the original extended device is released, and the functions of the keys of the remote controller can be adjusted therewith. This can achieve the object of controlling multiple extended devices using one remote controller and the operation convenience.

In the multimedia playback system and method of detecting an extended device thereof according to the embodiments of the invention, because the system bus of the multimedia playback system includes various video buses and audio buses and has the firmware of detecting the extended device, the extensibility of the multimedia playback system is greatly enhanced. Unlike the prior art drawbacks of modifying the internal design in response to the added peripheral device in a time-consuming and labor-consuming manner, the invention has a low cost and an enhanced boundary efficiency.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of detecting an extended device, applied to a multimedia playback system, the multimedia playback system comprising a system bus and a host, the system bus comprising a control bus, a plurality of video buses and a plurality of audio buses, the method comprising the steps of:
detecting an identification (ID) of the extended device through the control bus by the host;
respectively detecting the video buses to determine the video bus coupled to the extended device by the host; and
respectively detecting the audio buses to determine the audio bus coupled to the extended device.

2. The method according to claim 1, wherein the control bus satisfies a RS422 (Recommended Standard-422) interface specification.

3. The method according to claim 1, wherein the control bus satisfies an I2C (Inter-Integrated Circuit) specification.

4. The method according to claim 1, wherein the extended device further comprises a switch coupled to a control wire of the control bus, the control wire is biased at a high level at first, and the step of detecting the identification comprises:
querying the extended device according to identification data by the host, wherein the identification data comprise a plurality of default identifications, wherein the host selects one of the default identifications and queries the extended device accordingly;
turning on the switch to bias the control wire at a low level by the extended device if the selected default identification is the same as the identification of the extended device; and
verifying the identification corresponding to the extended device via the host according to the control wire biased at the low level.

5. The method according to claim 4, wherein the identification of the extended device is queried by a sequential search method in the step of querying the extended device.

6. The method according to claim 4, wherein the identification of the extended device is queried by a binary search method in the step of querying the extended device.

7. The method according to claim 1, wherein the video buses satisfy one of a low voltage differential signaling (LVDS) specification, a digital visual interface (DVI) specification, a chromatic video specification, an S video specification, and a composite video specification.

8. The method according to claim 1, wherein the extended device further comprises a switch coupled to a conductive wire of the video bus, the conductive wire is biased at a high level at first, and the step of detecting the video bus comprises:
selecting one of the video buses;
selecting a default identification;
outputting a driving command, comprising the default identification, to the selected video bus, wherein the extended device receives the driving command if the extended device is electrically coupled to the selected video bus;
verifying whether or not the default identification is the identification of the extended device, and turning on the switch, if yes, to bias the conductive wire at a low level; and
verifying that the extended device is located at the selected video bus if the host detects that the conductive wire of the video bus is at the low level.

9. The method according to claim 8, wherein the conductive wire further transmits a video signal.

10. The method according to claim 1, wherein the audio buses satisfy one of an I2S (Inter-IC Sound) interface specification, a SPDIF (Sony/Philips Digital Interface Format) interface specification, and an AC′97 (Audio Codec′97) specification.

11. The method according to claim 1, wherein the extended device further comprises a switch coupled to a conductive wire of the audio bus, the conductive wire is biased at a high level at first, and the step of detecting the audio bus comprises:
selecting one of the audio buses;
outputting a driving command, comprising the default identification, to the selected audio bus, wherein the extended device receives the driving command if the extended device is electrically coupled to the selected audio bus;
verifying whether or not the default identification is the identification of the extended device, and turning on the switch, if yes, to bias the conductive wire at a low level; and
verifying that the extended device is located at the selected audio bus if the host detects that the conductive wire of the audio bus is at the low level.

12. The method according to claim 11, wherein the conductive wire further transmits an audio signal.

13. A multimedia playback system, comprising:
a system bus, which comprises:
a control bus;
a plurality of video buses; and
a plurality of audio buses;
an extended device, for outputting a video signal and an audio signal through the video bus and the audio bus electrically coupled to the extended device, respectively; and
a host, electrically coupled to the system bus, for receiving and playing the video signal and the audio signal;
wherein the host detects an identification of the extended device through the control bus, and detects the video buses and the audio buses to determine the video bus and the audio bus coupled to the extended device through the system bus, respectively.

14. The system according to claim 13, wherein the control bus satisfies a RS422 (Recommended Standard-422) interface specification.

15. The system according to claim 13, wherein the control bus satisfies an I2C (Inter-Integrated Circuit) specification.

16. The system according to claim 13, wherein:
the extended device further comprises a switch coupled to a control wire of the control bus;
the host biases the control wire at a high level at first;
the host queries the extended device according to identification data, comprising a plurality of default identifications;
the host selects one of the default identifications and queries the extended device accordingly;
the extended device turns on the switch to bias the control wire at a low level if the selected default identification is the same as the identification of the extended device; and
the host verifies the identification corresponding to the extended device according to the control wire biased at the low level.

17. The system according to claim 16, wherein the host queries the default identification of the extended device by a sequential search method.

18. The system according to claim 16, wherein the host queries the default identification of the extended device by a binary search method.

19. The system according to claim 13, wherein the video buses satisfy one of a low voltage differential signaling (LVDS) specification, a digital visual interface (DVI) specification, a chromatic video specification, an S video specification, and a composite video specification.

20. The system according to claim 13, wherein:
the extended device further comprises a switch coupled to a conductive wire of the video bus;
the conductive wire is biased at a high level at first;
the host selects one of the video buses;
the host selects a driving command, comprising a default identification, and outputs the driving command to the selected video bus;
the extended device receives the driving command if the extended device is electrically coupled to the selected video bus;
the host verifies whether or not the default identification is the identification of the extended device, and turns on the switch, if yes, to bias the conductive wire at a low level; and
the host verifies that the extended device is located at the selected video bus if the host detects that the conductive wire of the video bus is at the low level.

21. The system according to claim 20, wherein the conductive wire further transmits the video signal.

22. The system according to claim 13, wherein the audio buses satisfy one of an I2S (Inter-IC Sound) interface specification, a SPDIF (Sony/Philips Digital Interface Format) interface specification, and an AC'97 (Audio Codec '97) specification.

23. The system according to claim 13, wherein:
the extended device further comprises a switch coupled to a conductive wire of the audio bus;
the conductive wire is biased at a high level at first;
the host selects one of the audio buses and outputs a driving command, comprising a default identification, to the selected audio bus;
the extended device receives the driving command if the extended device is electrically coupled to the audio bus;
the host verifies whether or not the default identification is the identification of the extended device, and turns on the switch, if yes, to bias the conductive wire at a low level; and
the host verifies that the extended device is located at the selected audio bus if the host detects that the conductive wire of the audio bus is at the low level.

24. The system according to claim 23, wherein the conductive wire further transmits the audio signal.
